(19) United States
(12) Patent Application Publication
(10) Pub. No.: US 2025/0276275 A1
(43) Pub. Date: Sep. 4, 2025

(54) PROCESS TO PURIFY HELIUM FROM METHANE WITH INTEGRATED NITROGEN REJECTION USING MEMBRANE TECHNOLOGY

(71) Applicant: Air Liquide Advanced Technologies U.S. LLC, Houston, TX (US)

(72) Inventors: Paul TERRIEN, Houston, TX (US); Kirsten O'SULLIVAN, Houston, TX (US)

(73) Assignee: Air Liquide Advanced Technologies U.S. LLC, Houston, TX (US)

(21) Appl. No.: 19/066,770

(22) Filed: Feb. 28, 2025

Related U.S. Application Data
(60) Provisional application No. 63/559,277, filed on Feb. 29, 2024.

(51) Int. Cl. B01D 53/22; B01D 53/047; C01B 3/50; C01B 3/56; C01B 23/00

(52) U.S. Cl. CPC B01D 53/229; B01D 53/047; B01D 53/226; B01D 53/227; C01B 3/501; C01B 3/56; C01B 23/0042; C01B 23/0052; B01D 2256/16; B01D 2256/18; B01D 2257/102; B01D 2257/7025; C01B 2203/0405; C01B 2203/042; C01B 2210/001; C01B 2210/0014; C01B 2210/0031; C01B 2210/0046; C01B 2210/007; C01P 2006/80

(57) ABSTRACT

A process to purify helium from a feed gas stream containing a mixture of at least nitrogen, methane and helium including introducing the feed gas stream into a first helium membrane separation unit, thereby producing a first helium membrane permeate and a first helium membrane residue; introducing at least part of the first residue into a first nitrogen membrane separation unit thereby producing a first nitrogen membrane permeate stream; introducing a stream derived from the first helium membrane permeate into a hydrogen PSA unit thereby producing a helium rich product stream. Wherein a stream derived from the first nitrogen membrane permeate stream exits the system as a fuel gas product stream. Wherein the feed gas stream has a higher heating value, and wherein the first nitrogen membrane permeate stream has a higher heating value at least 5% higher than the higher heating value of the feed gas.

### CROSS REFERENCE TO RELATED APPLICATIONS

This application claims the benefit of priority under 35 U.S.C. § 119 (a) and (b) to U.S. Provisional Patent Application No. 63/559,277, filed Feb. 29, 2024, the entire contents of which are incorporated herein by reference.

### BACKGROUND

Helium is a valuable molecule that can be found by extracting gas mixtures, like natural gas, from the earth. Since helium is typically a small fraction of the gas mixture, it must be highly purified in order to be used. In some instances, and the waste gas remaining from this process may also contain valuable molecules, like methane, that can be further purified and used.

While purifying helium from a methane/nitrogen mixture with membrane and pressure swing adsorption (PSA) technology is known in the art, the residue gas is often a mixture of methane and nitrogen in similar proportions as the feed gas. While there are known methods to reject nitrogen from methane, a membrane-based solution is desired as it complements the simplicity of the helium purification process. Proposed is a simple and cost effective process of purifying both helium and natural gas using membrane and adsorption technologies.

### SUMMARY

A process to purify helium from a feed gas stream containing a mixture of at least nitrogen, methane and helium including introducing the feed gas stream into a first helium membrane separation unit, thereby producing a first helium membrane permeate and a first helium membrane residue; introducing at least part of the first residue into a first nitrogen membrane separation unit thereby producing a first nitrogen membrane permeate stream; introducing a stream derived from the first helium membrane permeate into a hydrogen PSA unit thereby producing a helium rich product stream. Wherein a stream derived from the first nitrogen membrane permeate stream exits the system as a fuel gas product stream. Wherein the feed gas stream has a higher heating value, and wherein the first nitrogen membrane permeate stream has a higher heating value at least 5% higher than the higher heating value of the feed gas.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a system in accordance with one embodiment of the present invention.

FIG. 2 is another schematic representation of a system in accordance with one embodiment of the present invention.

### ELEMENT NUMBERS

101=feed gas stream
102=first helium membrane separation unit
103=first helium membrane separation permeate stream
104=first helium membrane separation residue stream
105=main compressor
106=compressed first helium membrane separation residue stream
107=second helium membrane separation unit
108=second helium membrane separation permeate stream
109=second helium membrane separation residue stream
110=PSA compressor
111=compressed PSA feed stream
112=helium PSA
113=PSA waste stream
114=purified helium stream
115=helium compressor
116=pressurized helium product stream
117=first nitrogen membrane separation unit
118=first nitrogen membrane separation residue stream
119=first nitrogen membrane separation permeate stream
120=first combined stream
121=second nitrogen membrane separation unit
122=second nitrogen membrane separation residue stream
123=second nitrogen membrane separation permeate stream
124=fuel gas stream
201=second combined stream
202=compressed second combined stream
203=PSA recycle stream
204=first recycle compressor
205=first recycle stream
206=third helium membrane separation unit
207=third helium membrane separation permeate stream
208=third helium membrane separation residue stream
209=third nitrogen membrane separation unit
210=third nitrogen membrane separation permeate stream
211=third nitrogen membrane separation residue stream
212=second recycle compressor
213=second recycle stream
214=third combined stream

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The following description explicitly refers to helium as the target gas, but the skilled artisan will also recognize that this same process may be utilized to separate hydrogen from a feed gas stream containing a mixture of at least nitrogen, methane and hydrogen. One of ordinary skill in the art will recognize that modifying the following process will involve the selection of hydrogen permeable membranes and a PSA that is designed to purify hydrogen. But with little experimentation, the skilled artisan will be able to modify this process to purify hydrogen.

As used herein, the term “approximately the same” is defined as being within 10%, preferably 5%, and more preferably 1% of the same measured value.

As used herein, the term “Helium rich” is defined as having a Helium concentration greater than 97% by volume, preferably greater than 98% by volume.

As used herein, the term “ultra-high purity Helium” is defined as having a helium concentration greater than 99.9% by volume, preferably greater than 99.99% by volume, more preferably greater than 99.999% by volume.

As used herein, the term “helium membrane separation unit” is defined as a device that utilizes a semipermeable barrier (membrane) that is selective for helium, and thus is used to separate helium from a mixture of gases.

As used herein, the term “helium pressure swing adsorption unit” is defined as a device that utilizes a adsorbent beds that are selective for helium, and thus is used to separate helium from a mixture of gases.

The present invention may be used to retrofit an existing process that utilizes membrane separation (and optionally additional helium pressure swing adsorption (PSA)) for helium purification from methane, nitrogen, or other slow gases. A key innovative element of this process is the addition of a nitrogen rejection unit (NRU) using membranes to further purify the helium process off-gas by removing any residual nitrogen, thus resulting in a usable fuel gas.

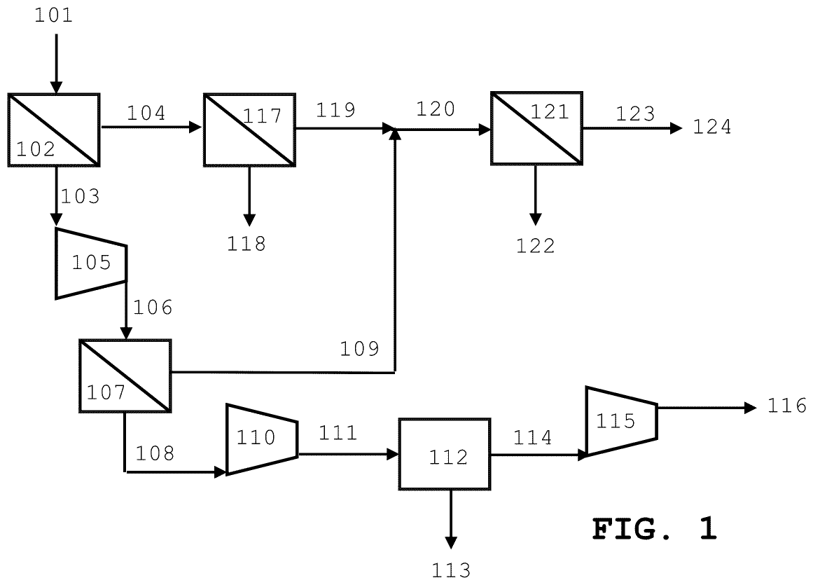

Turning to FIG. 1, one embodiment of the present invention is presented. Feed gas stream 101 is introduced into first helium membrane separation unit 102, thereby producing first helium membrane separation permeate stream 103 and first helium membrane separation residue stream 104. Feed gas stream 101 is comprised of, at least, nitrogen, methane, and helium. Feed gas stream 101 has a first Higher Heating Value (HHV). First helium membrane separation residue stream 104 has a first pressure P1. First helium membrane separation permeate stream 103 is introduced into main compressor 105, thereby producing compressed first helium membrane separation permeate stream 106. Compressed first helium membrane separation permeate stream 106 is introduced into second helium membrane separation unit 107, thereby producing second helium membrane separation residue stream 109 and second helium membrane separation permeate stream 108. Second helium membrane separation residue stream 109 has a second pressure P2.

Second helium membrane separation permeate stream 108 is introduced into PSA compressor 110, thereby producing compressed PSA feed stream 111. Compressed PSA feed stream 111 is introduced into helium PSA 112, thereby producing PSA waste stream 113 and purified helium stream 114. Purified helium stream 114 comprises a Ultra-High purity Helium stream Purified helium stream 114 is introduced into helium compressor 115, thereby producing pressurized helium product stream 116.

First helium membrane separation residue stream 104 is introduced into first nitrogen membrane separation unit 117, thereby producing first nitrogen membrane separation residue stream 118 and first nitrogen membrane separation permeate stream 119. First nitrogen membrane separation permeate stream 119 has a third pressure P3. First nitrogen membrane separation permeate stream 119 has a second higher heating value. In one embodiment, the second higher heating value is at least 5% higher than the first higher heating value. In one embodiment of the present invention, P2 is as close as possible to P3. First nitrogen membrane separation residue stream 118 is generally considered to be a waste stream. First nitrogen membrane separation permeate stream 119 is combined with second helium membrane separation residue stream 109 to produce first combined stream 120. First combined stream 120 is introduced into second nitrogen membrane separation unit 121, thereby producing second nitrogen membrane separation residue stream 122 and second nitrogen membrane separation permeate stream 123. Second nitrogen membrane separation permeate stream 123 has a fourth pressure P4. Second nitrogen membrane separation residue stream 122 is generally considered to be a waste stream. Second nitrogen membrane separation permeate stream 123 leaves the system as fuel gas stream 124.

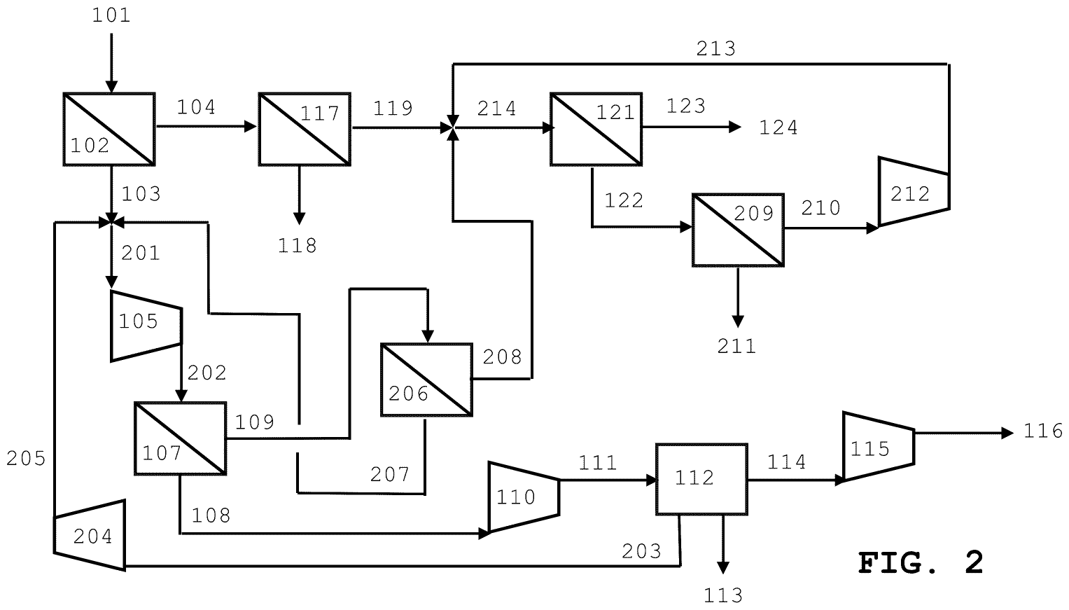

Turning to FIG. 2, another embodiment of the present invention is presented. Feed gas 101 is introduced into first helium membrane separation unit 102, thereby producing first helium membrane separation permeate stream 103 and first helium membrane separation residue stream 104. Feed gas stream 101 is comprised of, at least, nitrogen, methane, and helium. Feed gas stream 101 has a first Higher Heating Value (HHV). First helium membrane separation permeate stream 103 is combined with first recycle stream 205 and third helium membrane separation permeate stream 207 thereby producing second combined stream 201. Second combined stream 201 is introduced into main compressor 105, thereby producing compressed second combined stream 202. Compressed second combined stream 202 is introduced into second helium membrane separation unit 107, thereby producing second helium membrane separation permeate stream 108 and second helium membrane separation residue stream 109. Second helium membrane separation permeate stream 108 comprises a Helium rich stream. Second helium membrane separation permeate stream 108 is introduced into third helium membrane separation unit 206, thereby producing third helium membrane separation permeate stream 207 and third helium membrane separation residue stream 208. Second helium membrane separation residue stream 109 is introduced into PSA compressor 110, thereby producing compressed PSA feed stream 111. Compressed PSA feed stream 111 is introduced into helium PSA 112, thereby producing PSA waste stream 113, PSA recycle stream 203, and purified helium stream 114. Purified helium stream 114 comprises a Ultra-High purity Helium stream. Purified helium stream 114 is introduced into helium compressor 115, thereby producing pressurized helium product stream 116. PSA recycle stream 203 is introduced into first recycle compressor 204, thereby producing first recycle stream 205.

First helium membrane separation residue stream 104 is introduced into first nitrogen membrane separation unit 117, thereby producing first nitrogen membrane separation residue stream 118 and first nitrogen membrane separation permeate stream 119. First nitrogen membrane separation permeate stream 119 has a second higher heating value. In one embodiment, the second higher heating value is at least 5% higher than the first higher heating value. First nitrogen membrane separation permeate stream 119 has a fifth pressure P5. In one embodiment of the present invention, P2, P4, and P5 are as close as possible to one another. First nitrogen membrane separation residue stream 118 is generally considered to be a waste stream. First nitrogen membrane separation permeate stream 119 is combined with third helium membrane separation residue stream 208 and second compressed recycle stream 213 to produce third combined stream 214. Third combined stream 214 is introduced into second nitrogen membrane separation unit 121, thereby producing second nitrogen membrane separation residue stream 122 and second nitrogen membrane separation permeate stream 123. Second nitrogen membrane separation residue stream 122 is generally considered to be a waste stream. Second nitrogen membrane separation permeate stream 123 leaves the system as fuel gas stream 124.

Second nitrogen membrane separation residue stream 122 is introduced into third nitrogen membrane separation unit 209, thereby producing third nitrogen membrane separation residue stream 211 and third nitrogen membrane separation permeate stream 210. Third nitrogen membrane separation residue stream 211 is generally consider to be a waste stream. Third nitrogen membrane separation permeate stream 210 is introduced into second recycle compressor 212, thereby producing second compressed recycle stream 213.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1: A process to purify helium from a feed gas stream 101 containing a mixture of at least nitrogen, methane and helium comprising:
introducing the feed gas stream 101 into a first helium membrane separation unit 102, thereby producing a first helium membrane permeate 103 and a first helium membrane residue 104 at a first pressure P1;
introducing at least part of the first residue 104 in a first nitrogen membrane separation unit 117 thereby producing a first nitrogen membrane permeate stream 119 at a third pressure P3 and a first nitrogen membrane residue stream 118;
introducing a stream derived from the first helium membrane permeate 103 into a hydrogen PSA unit 112 thereby producing a helium rich product stream 116;
wherein a stream derived from the first nitrogen membrane permeate stream 119 exits the system as a fuel gas product stream 124;
wherein the feed gas stream 101 has a first higher heating value, and
wherein the first nitrogen membrane permeate stream 119 has a second higher heating value,
wherein the second higher heating value is at least 5% higher than the first higher heating value.

2: The process according to claim 1, further comprising:
compressing the first helium membrane permeate 103, thereby producing a compressed first helium membrane permeate stream 106, and introducing the compressed first helium membrane permeate stream 106 into a second helium membrane separation unit 107, thereby obtaining a second helium membrane residue stream 109 at a second pressure P2, and a second helium membrane permeate stream 108 further enriched in helium;
wherein, at least part of the first nitrogen membrane permeate stream 119 and at least part of a stream derived from the second helium membrane residue stream 109 are combined 112 and introduced in a second nitrogen membrane separation unit 121 thereby obtaining a second nitrogen membrane separation permeate stream 123 and a second nitrogen membrane separation residue stream 122;
wherein the fuel gas product stream 124 is derived from the second nitrogen membrane separation permeate stream 123, and
wherein the first nitrogen membrane permeate stream 119 has a second higher heating value,
wherein the second higher heating value is at least 5% higher than the first higher heating value.

3: The process according to claim 2,
wherein the second nitrogen membrane separation permeate stream 123 has a fourth pressure P4;
wherein the first nitrogen membrane residue stream 118 has a fifth pressure P5, and
wherein P2, P4, and P5 are approximately the same.

4: A process to purify helium from a feed gas stream 101 containing a mixture of at least nitrogen, methane and helium comprising:
introducing the feed gas stream 101 into a first helium membrane separation unit 102, thereby producing a first helium membrane permeate 103 and a first helium membrane residue 104;
introducing at least part of the first residue 104 in a first nitrogen membrane separation unit 117 thereby producing a first nitrogen membrane permeate stream 119 and a first nitrogen membrane residue stream 118;
introducing at least part of the first nitrogen membrane permeate stream 119 into a second nitrogen membrane separation unit 121, thereby producing a second nitrogen membrane permeate stream 123 and a second nitrogen membrane residue stream 122;
introducing at least part of the second nitrogen membrane residue stream 122 into a third nitrogen membrane separation unit 209, thereby producing a third nitrogen membrane permeate stream 210 and a third nitrogen membrane residue stream 211;
and
introducing a stream derived from the second helium membrane permeate stream 109 into a hydrogen PSA unit 112 thereby producing a helium rich product stream 116;
wherein a stream derived from the second nitrogen membrane permeate stream 123 exits the system as a fuel gas product stream 124.

5: The process according to claim 4, further comprising a recycle compressor,
wherein at least part of the third nitrogen membrane permeate stream 210 is recycled and combined with at least part of the first nitrogen membrane permeate stream 119.

6: The process according to claim 4, further comprising a recycle compressor,
wherein at least part of the third nitrogen membrane permeate stream 210 is recycled and combined with at least part of the first nitrogen membrane permeate stream 119 and at least part of the third helium membrane residue stream 208.

7: The process of claim 4, further comprising:
introducing at least part of the first helium membrane permeate 103 into a second helium membrane separation unit 107, thereby producing a second helium membrane residue stream 109 and a second helium membrane permeate stream 108; and
introducing at least part of the second helium membrane permeate stream 108 into a third helium membrane separation unit 206, thereby producing a third helium membrane permeate stream 207 and a third helium membrane residue stream 208.

8: A process to purify hydrogen from a feed gas stream 101 containing a mixture of at least nitrogen, methane and hydrogen comprising:
introducing the feed gas stream 101 into a first hydrogen membrane separation unit 102, thereby producing a first hydrogen membrane permeate 103 and a first hydrogen membrane residue 104 at a first pressure P1;
introducing at least part of the first residue 104 in a first nitrogen membrane separation unit 117 thereby producing a first nitrogen membrane permeate stream 119 at a third pressure P3 and a first nitrogen membrane residue stream 118;
introducing a stream derived from the first hydrogen membrane permeate 103 into a hydrogen PSA unit 112 thereby producing a hydrogen rich product stream 116;
wherein a stream derived from the first nitrogen membrane permeate stream 119 exits the system as a fuel gas product stream 124;
wherein the feed gas stream 101 has a first higher heating value, and
wherein the first nitrogen membrane permeate stream 119 has a second higher heating value,
wherein the second higher heating value is at least 5% higher than the first higher heating value.

9: The process according to claim 8, further comprising:
compressing the first hydrogen membrane permeate 103, thereby producing a compressed first hydrogen membrane permeate stream 106, and introducing the compressed first hydrogen membrane permeate stream 106 into a second hydrogen membrane separation unit 107, thereby obtaining a second hydrogen membrane residue stream 109 at a second pressure P2, and a second hydrogen membrane permeate stream 108 further enriched in hydrogen;
wherein, at least part of the first nitrogen membrane permeate stream 119 and at least part of a stream derived from the second hydrogen membrane residue stream 109 are combined 112 and introduced in a second nitrogen membrane separation unit 121 thereby obtaining a second nitrogen membrane separation permeate stream 123 and a second nitrogen membrane separation residue stream 122;
wherein the fuel gas product stream 124 is derived from the second nitrogen membrane separation permeate stream 123, and
wherein the first nitrogen membrane permeate stream 119 has a second higher heating value,
wherein the second higher heating value is at least 5% higher than the first higher heating value.

10: The process according to claim 9,
wherein the second nitrogen membrane separation permeate stream 123 has a fourth pressure P4;
wherein the first nitrogen membrane residue stream 118 has a fifth pressure P5, and
wherein P2, P4, and P5 are approximately the same.

11: A process to purify hydrogen from a feed gas stream 101 containing a mixture of at least nitrogen, methane and hydrogen comprising:
introducing the feed gas stream 101 into a first hydrogen membrane separation unit 102, thereby producing a first hydrogen membrane permeate 103 and a first hydrogen membrane residue 104;
introducing at least part of the first residue 104 in a first nitrogen membrane separation unit 117 thereby producing a first nitrogen membrane permeate stream 119 and a first nitrogen membrane residue stream 118;
introducing at least part of the first nitrogen membrane permeate stream 119 into a second nitrogen membrane separation unit 121, thereby producing a second nitrogen membrane permeate stream 123 and a second nitrogen membrane residue stream 122;
introducing at least part of the second nitrogen membrane residue stream 122 into a third nitrogen membrane separation unit 209, thereby producing a third nitrogen membrane permeate stream 210 and a third nitrogen membrane residue stream 211;
and
introducing a stream derived from the second hydrogen membrane permeate stream 109 into a hydrogen PSA unit 112 thereby producing a hydrogen rich product stream 116;
wherein a stream derived from the second nitrogen membrane permeate stream 123 exits the system as a fuel gas product stream 124.

12: The process according to claim 11, further comprising a recycle compressor,
wherein at least part of the third nitrogen membrane permeate stream 210 is recycled and combined with at least part of the first nitrogen membrane permeate stream 119.

13: The process according to claim 11, further comprising a recycle compressor,
wherein at least part of the third nitrogen membrane permeate stream 210 is recycled and combined with at least part of the first nitrogen membrane permeate stream 119 and at least part of the third hydrogen membrane residue stream 208.

14: The process of claim 11, further comprising:
introducing at least part of the first hydrogen membrane permeate 103 into a second hydrogen membrane separation unit 107, thereby producing a second hydrogen membrane residue stream 109 and a second hydrogen membrane permeate stream 108; and
introducing at least part of the second hydrogen membrane permeate stream 108 into a third hydrogen membrane separation unit 206, thereby producing a third hydrogen membrane permeate stream 207 and a third hydrogen membrane residue stream 208.
